(19) United States
(12) Patent Application Publication
(10) Pub. No.: US 2019/0324329 A1
(43) Pub. Date: Oct. 24, 2019

(54) DISPLAY DEVICE

(71) Applicant: Samsung Display Co., Ltd., Yongin-si (KR)

(72) Inventors: Joonggun CHONG, Yongin-si (KR); Wonjun LEE, Changwon-si (KR); Younhak JEONG, Cheonan-si (KR); Doohwan YOU, Seoul (KR)

(21) Appl. No.: 16/189,607

(22) Filed: Nov. 13, 2018

(30) Foreign Application Priority Data
Apr. 19, 2018 (KR) 10-2018-0045497

(51) Int. Cl. G02F 1/1343; G02F 1/1368; G02F 1/1362

(52) U.S. Cl. CPC G02F 1/134309; G02F 1/1368; G02F 2201/121; G02F 2201/123; G02F 1/136286

(57) ABSTRACT

A display device is capable of improving transmittance and side visibility, the display device including: a substrate; a thin film transistor disposed on the substrate; and a pixel electrode disposed on the thin film transistor and comprising a first sub-pixel electrode and a second sub-pixel electrode connected to the first sub-pixel electrode. The first sub-pixel electrode includes a plurality of first branch portions. The second sub-pixel electrode includes a plurality of second branch portions. The plurality of second branch portions are arranged at a pitch substantially equal to a pitch of the plurality of first branch portions. An interval between the plurality of second branch portions is greater than an interval between the plurality of first branch portions.

### CROSS-REFERENCE TO RELATED APPLICATION

This application claims priority under 35 U.S.C. § 119 to Korean Patent Application No. 10-2018-0045497, filed on Apr. 19, 2018, in the Korean Intellectual Property Office (KIPO), the disclosure of which is incorporated by reference herein in its entirety.

### 1. TECHNICAL FIELD

Embodiments of the present inventive concept relate to a display device.

### 2. DISCUSSION OF RELATED ART

Liquid crystal display (“LCD”) devices are one of the most widely used types of flat panel display (“FPD”) devices. The LCD device includes two substrates on which electrodes are formed and a liquid crystal layer interposed therebetween.

The LCD device is a display device that adjusts the amount of transmitted light through a liquid crystal layer by applying voltages to two electrodes and rearranging liquid crystal molecules in the liquid crystal layer.

In such a case, the LCD device may adjust the transmittance according to the liquid crystal controllability, and the liquid crystal controllability may be adjusted according to the electric field formed by a pixel electrode and a common electrode.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Embodiments according to an embodiment of the present inventive concept may be directed to a display device capable of improving transmittance and side visibility.

According to an embodiment, a display device includes: a substrate; a thin film transistor disposed on the substrate; and a pixel electrode disposed on the thin film transistor and comprising a first sub-pixel electrode and a second sub-pixel electrode connected to the first sub-pixel electrode. The first sub-pixel electrode includes a first horizontal stem portion extending along a first direction, a first vertical stem portion extending along a second direction that intersects the first direction, and a plurality of first branch portions obliquely extending from at least one of the first horizontal stem portion and the first vertical stem portion. The second sub-pixel electrode includes a second horizontal stem portion extending along the first direction, a second vertical stem portion extending along the second direction, and a plurality of second branch portions obliquely extending from at least one of the second horizontal stem portion and the second vertical stem portion. The plurality of second branch portions are arranged at a pitch substantially equal to a pitch of the plurality of first branch portions. An interval between the plurality of second branch portions is greater than an interval between the plurality of first branch portions.

A ratio of a width of each of the plurality of first branch portions to an interval between the plurality of first branch portions may be greater than a ratio of a width of each of the plurality of second branch portions to an interval between the plurality of second branch portions.

The ratio of the width of each of the plurality of first branch portions to the interval between the plurality of first branch portions may be about 1.2 or more and about 1.7 or less.

The ratio of the width of each of the plurality of second branch portions to the interval between the plurality of second branch portions may be about 0.9 or more and about 1.2 or less.

The plurality of first branch portions are arranged at a pitch of about 5 μm or more and about 7 μm or less, and the plurality of second branch portions may be arranged at a pitch of about 5 μm or more and about 7 μm or less.

The display device may further include a first organic layer disposed between the thin film transistor and the pixel electrode; and a second organic layer disposed on the second sub-pixel electrode.

The first organic layer that overlaps the first sub-pixel electrode may have a thickness larger than a thickness of the first organic layer that overlaps the second sub-pixel electrode.

The second organic layer may not be disposed on the first sub-pixel electrode.

Each of the plurality of second branch portions may have a width less than a width of each of the plurality of first branch portions.

The pixel electrode may further include a first connection portion which is connected to the thin film transistor, and a second connection portion which connects the first sub-pixel electrode and the second sub-pixel electrode.

The first branch portion and the first horizontal stem portion may form an angle different from an angle between the second branch portion and the second horizontal stem portion.

The first branch portion and the first horizontal stem portion may form an angle of about 40 degrees or more and about 50 degrees or less.

The second branch portion and the second horizontal stem portion may form an angle of about 25 degrees or more and about 40 degrees or less.

The first sub-pixel electrode comprises an outer electrode connecting end portions of the first branch portions.

According to an embodiment, a display device includes: a substrate; a thin film transistor disposed on the substrate; and a pixel electrode disposed on the thin film transistor and comprising a first sub-pixel electrode and a second sub-pixel electrode connected to the first sub-pixel electrode. The first sub-pixel electrode includes a first horizontal stem portion extending along a first direction, a first vertical stem portion extending along a second direction that intersects the first direction, and a plurality of first branch portions obliquely extending from at least one of the first horizontal stem portion and the first vertical stem portion. The second sub-pixel electrode includes a second horizontal stem portion extending along the first direction, a second vertical stem portion extending along the second direction, and a plurality of second branch portions obliquely extending from at least one of the second horizontal stem portion and the second vertical stem portion. A ratio of a width of each of the plurality of first branch portions to an interval between the plurality of first branch portions is about 1.2 or more and about 1.7 or less. A ratio of a width of each of the plurality of second branch portions to an interval between the plurality of second branch portions is about 0.9 or more and about 1.2 or less.

The plurality of first branch portions may be arranged at a pitch of about 5 μm or more and about 7 μm or less, and the plurality of second branch portions may be arranged at a pitch of about 5 μm or more and about 7 μm or less.

The display device may further include a first organic layer disposed between the thin film transistor and the pixel electrode; and a second organic layer disposed on the second sub-pixel electrode.

The first organic layer that overlaps the first sub-pixel electrode may have a thickness larger than a thickness of the first organic layer that overlaps the second sub-pixel electrode.

The second organic layer may not be disposed on the first sub-pixel electrode.

Each of the plurality of second branch portions may have a width less than a width of each of the plurality of first branch portions.

According to an embodiment, a display device includes: a substrate; a thin film transistor disposed on the substrate; and a pixel electrode disposed on the thin film transistor and comprising a first sub-pixel electrode and a second sub-pixel electrode connected to the first sub-pixel electrode. The first sub-pixel electrode includes a first horizontal stem portion extending along a first direction, a first vertical stem portion extending along a second direction that intersects the first direction, and a plurality of first branch portions obliquely extending from at least one of the first horizontal stem portion and the first vertical stem portion. The second sub-pixel electrode includes a second horizontal stem portion extending along the first direction, a second vertical stem portion extending along the second direction, and a plurality of second branch portions obliquely extending from at least one of the second horizontal stem portion and the second vertical stem portion. The plurality of second branch portions are arranged at a pitch substantially equal to a pitch of the plurality of first branch portions. Each of the plurality of second branch portions has a less width at a center portion than a width at an end portion.

The center portion of each of the plurality of second branch portions may have a width less than a width of each of the plurality of first branch portions.

The plurality of first branch portions may be arranged at a pitch of about 5 μm or more and about 7 μm or less, and the plurality of second branch portions may be arranged at a pitch of about 5 μm or more and about 7 μm or less.

The display device may further include a first organic layer disposed between the thin film transistor and the pixel electrode; and a second organic layer disposed on the second sub-pixel electrode.

The first organic layer that overlaps the first sub-pixel electrode may have a thickness larger than a thickness of the first organic layer that overlaps the second sub-pixel electrode.

The second organic layer may not be disposed on the first sub-pixel electrode.

The foregoing is illustrative only and is not intended to be in any way limiting. In addition to the illustrative aspects, embodiments and features described above, further aspects, embodiments and features will become apparent by reference to the drawings and the following detailed description.

### BRIEF DESCRIPTION OF THE DRAWINGS

A more complete appreciation according to an embodiment of the present inventive concept will become more apparent by describing in detail embodiments thereof with reference to the accompanying drawings, wherein:

FIG. 1 is a schematic block diagram illustrating a display device of the present inventive concept;

FIG. 2 is an equivalent circuit diagram illustrating one pixel illustrated in FIG. 1;

FIG. 3 is a plan view illustrating one pixel according to a first embodiment of the present inventive concept;

FIG. 4 is a cross-sectional view taken along line I-I′ of FIG. 3;

FIG. 5 is an enlarged view illustrating A in FIG. 3;

FIG. 6 is a cross-sectional view taken along line II-II′ of FIG. 5;

FIG. 7 is an enlarged view illustrating B in FIG. 3;

FIG. 8 is a cross-sectional view taken along line III-III′ of FIG. 7;

FIG. 9 is a plan view illustrating one pixel electrode according to a second embodiment of the present inventive concept;

FIG. 10 is an enlarged view illustrating C in FIG. 9;

FIG. 11 is an enlarged view illustrating D in FIG. 9;

FIG. 12 is a plan view illustrating one pixel electrode according to a third embodiment of the present inventive concept;

FIG. 13 is an enlarged view illustrating E in FIG. 12; and

FIG. 14 is an enlarged view illustrating F in FIG. 12.

### DETAILED DESCRIPTION

Embodiments will now be described more fully hereinafter with reference to the accompanying drawings. Although the inventive concept may be modified in various manners and have several embodiments, embodiments are illustrated in the accompanying drawings and will be mainly described in the specification. However, the scope of the inventive concept is not limited to the embodiments and should be construed as including all the changes, equivalents and substitutions included in the spirit and scope of the inventive concept.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper”, or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “including,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first,” “second,” “third,”, or the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 80%, 5% of the stated value.

Unless otherwise defined, all terms used herein (including technical and scientific terms) have the same meaning as commonly understood by those skilled in the art to which this inventive concept pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe embodiments according to an embodiment of the present inventive concept and like reference numerals refer to like elements throughout the specification.

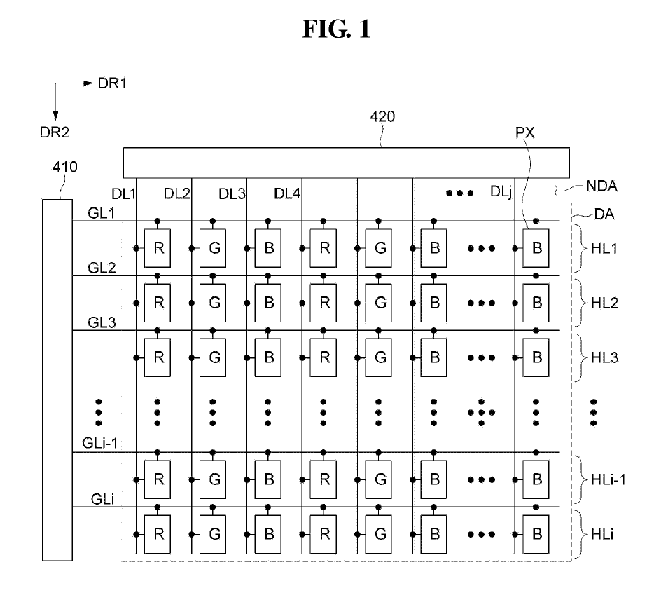

Hereinafter, a display device according to a first embodiment of the present inventive concept will be described in detail with reference to FIGS. 1 to 8.

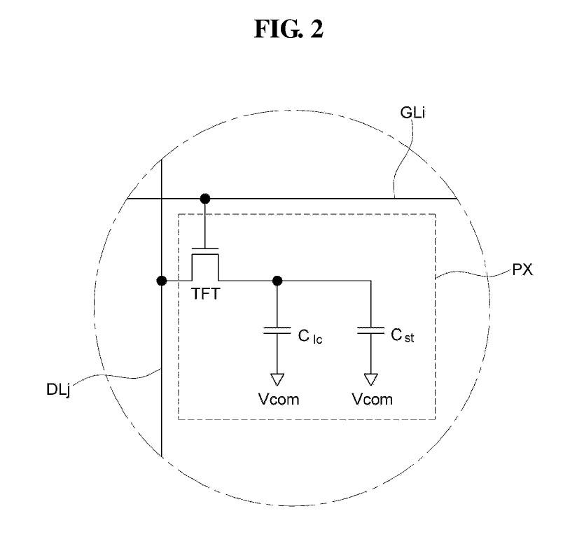

FIG. 1 is a schematic block diagram illustrating a display device of the present inventive concept, and FIG. 2 is an equivalent circuit diagram illustrating one pixel illustrated in FIG. 1.

Referring to FIG. 1, a display device according to a first embodiment of the present inventive concept includes a display panel having a display area DA and a non-display area NDA around the display area DA, and further includes a gate driver 410 and a data driver 420 disposed in the non-display area NDA of the display panel.

The display panel includes a plurality of gate lines GL1 to GLi extending in a first direction DR1, a plurality of data lines DL1 to DLj extending in a second direction DR2 that intersects the first direction DR1, and a plurality of pixels PX connected to the gate lines and the data lines.

The gate lines GL1 to GLi extend to the non-display area NDA and are connected to the gate driver 410. The data lines DL1 to DLj extend to the non-display area NDA and are connected to the data driver 420

The gate driver 410 generates gate signals in accordance with a gate control signal provided from a timing controller (not illustrated), and sequentially applies the gate signals to the plurality of gate lines GL1 to GLi. The data driver 420 receives digital image data signals and a data control signal from the timing controller (not illustrated) and applies analog image data signals (a grayscale signal voltages) to the data lines DL1 to DLj.

The pixels PX are located at the display area DA of the display panel. A plurality of pixels PX that are positioned adjacent to each other may form one unit pixel. For example, the plurality of pixels PX defining one unit pixel may be connected to the same gate line and may be connected to different data lines.

The pixels PX are arranged in a matrix form. The pixels PX may include red pixels R located corresponding to red color filters, green pixels G located corresponding to green color filters, and blue pixels B located corresponding to blue color filters. In such an embodiment, a red pixel R, a green pixel B and a blue pixel B that are adjacently disposed in a horizontal direction may form a unit pixel for displaying a unit image.

There are “j” number of pixels arranged along a p-th (p being one selected from 1 to i) horizontal line (hereinafter, p-th horizontal line pixels), which are individually connected to the first to j-th data lines DL1 to DLj, respectively. In addition, the p-th horizontal line pixels are connected in common to a p-th gate line. Accordingly, the p-th horizontal line pixels receive a p-th gate signal as a common signal. That is, “j” number of pixels disposed in the same horizontal line all receive the same gate signal, while pixels disposed in different horizontal lines receive different gate signals, respectively. For example, the red pixel R, the green pixel G and the blue pixel B in a first horizontal line HL1 all receive a first gate signal, while the red pixel R, the green pixel G and the blue pixel B in a second horizontal line HL2 all receive a second gate signal that has an output timing which is different from an output timing of the first gate signal.

Each of the pixels PX includes a thin film transistor (“TFT”), a liquid crystal capacitor Clc, and a storage capacitor Cst, as illustrated in FIG. 2.

The TFT is turned on according to the gate signal applied from the gate line. The turned-on TFT applies the analog image data signals applied from the data line to the liquid crystal capacitor Clc and the storage capacitor Cst.

The liquid crystal capacitor Clc includes a pixel electrode PE, a common electrode 350 which oppose each other and a liquid crystal layer disposed therebetween.

The storage capacitor Cst includes a pixel electrode PE and an opposing electrode which oppose each other. Herein, the opposing electrode may be a previous gate line or a common line for transmitting a common voltage.

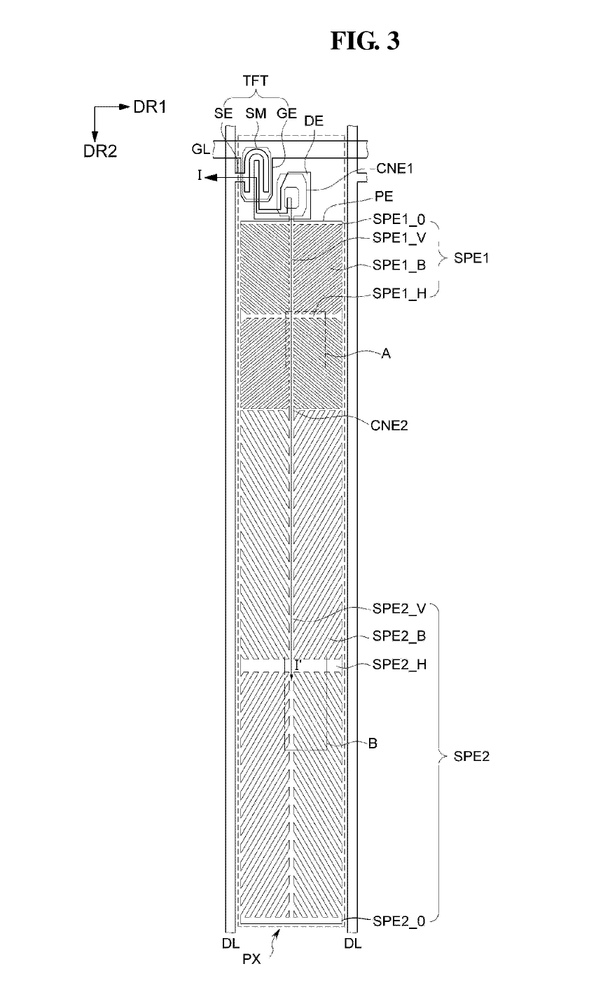

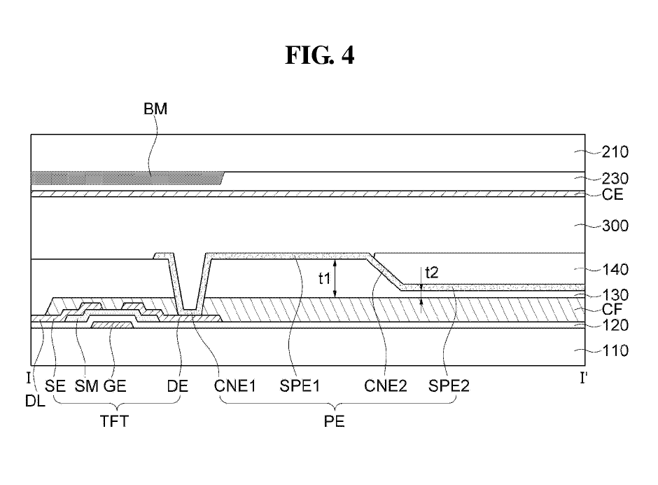

FIG. 3 is a plan view illustrating one pixel according to a first embodiment of the present inventive concept, and FIG. 4 is a cross-sectional view taken along line I-I′ of FIG. 3.

Referring to FIGS. 3 and 4, a display device according to the first embodiment of the present inventive concept includes a first substrate 110, a gate wiring GL and GE, a gate insulating layer 120, a semiconductor layer SM, a data wiring DL, SE, and DE, a color filter CF, a first organic layer 130, a second organic layer 140, a pixel electrode PE, a liquid crystal layer 300, a common electrode CE, and a second substrate 210.

The first substrate 110 may be an insulating substrate having light transmission characteristics and flexible characteristics, e.g., a plastic substrate. However, exemplary embodiments are not limited thereto, and the first substrate 110 may include a hard substrate such as a glass substrate.

The gate wiring GL and GE is disposed on the first substrate 110.

The gate wiring GL and GE includes a gate line GL extending in the first direction DR1 and a gate electrode GE branching from the gate line GL.

The gate wiring GL and GE may include: aluminum (Al) or alloys thereof, silver (Ag) or alloys thereof, copper (Cu) or alloys thereof, molybdenum (Mo) or alloys thereof, chromium (Cr), tantalum (Ta), and/or titanium (Ti).

In an exemplary embodiment, the gate wiring GL and GE may have a multilayer structure including at least two conductive layers (not illustrated) that have different physical properties. For example, one of the two conductive layers of the multilayer structure may include a metal having low resistivity to reduce signal delay or voltage drop, e.g., an aluminum-based metal, a silver-based metal, and a copper-based metal, and the other of the two conductive layers may include a material having excellent contact properties with indium tin oxide (ITO) and indium zinc oxide (IZO), e.g., a molybdenum-based metal, chromium, titanium, and tantalum.

Examples of the multilayer structure may include: a double-layer structure including a chromium lower layer and an aluminum upper layer; an aluminum lower layer and a molybdenum upper layer, a titanium lower layer and a copper upper layer, or the like. However, embodiments are not limited thereto, and the gate wiring GL and GE may include any suitable metals and/or conductors rather than the aforementioned materials. The gate wiring GL and GE may be substantially simultaneously formed in a substantially same process.

The gate insulating layer 120 is disposed on the base substrate 110 on which the gate wiring GL and GE is disposed. The gate insulating layer 120 may include silicon oxide (SiOx) or silicon nitride (SiNx). The gate insulating layer 120 may further include aluminum oxide, titanium oxide, tantalum oxide, or zirconium oxide.

A semiconductor layer SM is disposed on the gate insulating layer 120. The semiconductor layer SM may include amorphous silicon or an oxide semiconductor including at least one of gallium (Ga), indium (In), tin (Sn), and zinc (Zn). Although not illustrated in the drawing, an ohmic contact layer may be disposed on the semiconductor layer SM.

It is illustrated in FIG. 4 that the semiconductor layer SM substantially overlaps the gate electrode GE, but exemplary embodiments are not limited thereto. The semiconductor layer SM may be disposed so as to substantially overlap the data wiring DL, SE, and DE.

The data wiring DL, SE and DE is disposed on the base substrate 110 on which the semiconductor layer SM is arranged.

The data wiring DL, SE and DE includes the data line DL which extends in the second direction DR2 that intersects the first direction DR1, a source electrode SE which branches from the data line DL and overlaps the semiconductor layer SM, and a drain electrode which is spaced apart from the source electrode SE and overlaps the semiconductor layer SM. The data wiring DL, SE, and DE may include a material substantially the same as a material included in the gate wiring GL and GE described above. The data wiring DL, SE, and DE may be substantially simultaneously formed in a substantially same process.

The color filter CF is disposed on the first substrate 110 on which the data wiring DL, SE and DE is disposed. The color filters CF are located in a pixel area. The color filters CF include a red color filter, a green color filter, and a blue color filter.

The first organic layer 130 is disposed on the first substrate 110 on which the color filter CF is disposed. The first organic layer 130 may have a single-layer or multilayer structure including, for example, a photosensitive organic material, and a low dielectric constant insulating material such as a-Si:C:O, a-Si:O:F.

According to an embodiment of the present inventive concept, the first organic layer 130 may have different thicknesses depending on a sub-pixel electrode that the first organic layer 130 overlaps. In specific, a portion of the first organic layer 130 that overlaps a first sub-pixel electrode SPE1 to be described below has a first thickness t1, and a portion of the first organic layer 130 that overlaps a second sub-pixel electrode SPE2 to be described below has a second thickness t2 that is less than the first thickness (t1>t2). According to an embodiment of the present inventive concept, since portions of the first organic layer 130 that respectively overlap the first sub-pixel electrode SPE1 and the second sub-pixel electrode SPE2 have different thicknesses, the first sub-pixel electrode SPE1 and the common electrode CE are spaced apart from each other by a distance that is different from a distance by which the second sub-pixel electrode SPE2 and the common electrode CE are spaced apart from each other. A voltage is applied to the pixel electrode PE and the common electrode CE so that an electric field is formed between the pixel electrode PE and the common electrode CE, and the liquid crystal layer 300 disposed between the pixel electrode PE and the common electrode CE is arranged according to the electric field between the pixel electrode PE and the common electrode CE. In such a case, according to an exemplary embodiment of the present inventive concept, since the first sub-pixel electrode SPE1 and the common electrode CE are spaced apart from each other by a distance different from the distance by which the second sub-pixel electrode SPE2 and the common electrode CE are spaced apart from each other, the electric field formed between the first sub-pixel electrode SPE1 and the common electrode CE has an intensity different from that of the electric field between the second sub-pixel electrode SPE2 and the common electrode CE.

The pixel electrode PE is connected to the drain electrode DE of the thin film transistor TFT through the color filter CF and the first organic layer 130.

The pixel electrode PE may include a transparent conductive material. For example, the pixel electrode PE may include at least one selected from the group consisting of: indium tin oxide (ITO), indium zinc oxide (IZO), indium tin zinc oxide (ITZO), aluminum zinc oxide (AZO), and amorphous indium tin oxide (a-ITO).

According to a first embodiment of the present inventive concept, as illustrated in FIGS. 3 and 4, the pixel electrode PE includes a first connection electrode CNE1, a first sub-pixel electrode SPE1, a second connection electrode CNE2, and a second sub-pixel electrode SPE2.

The first connection electrode CNE1 connects the first sub-pixel electrode SPE1 and the thin film transistor TFT. Specifically, the first connection electrode CNE1 is connected to the drain electrode DE of the thin film transistor TFT through a contact hole.

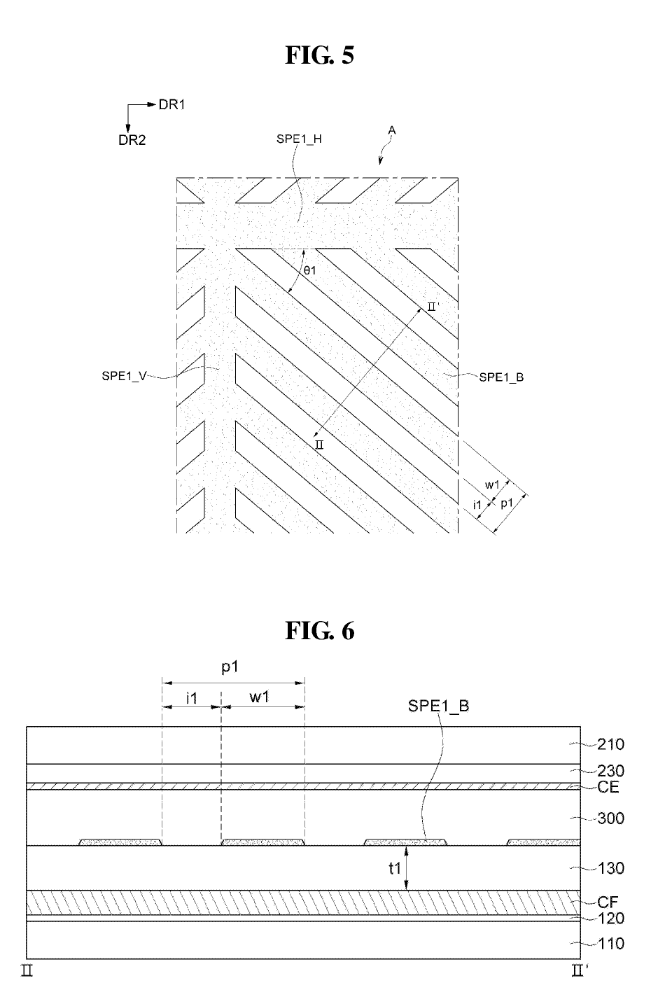

The first sub-pixel electrode SPE1 includes a first horizontal stem portion SPE1_H, a first vertical stem portion SPE1_V, a plurality of first branch portions SPE1_B, and a first outer portion SPE1_O. The first horizontal stem portion SPE1_H extends along the first direction DR1, and the first vertical stem portion SPE1_V extends along the second direction DR2 that intersects the first direction DR1. Each of the plurality of first branch portions SPE1_B extends obliquely from at least one of the first horizontal stem portion SPE1_H and the first vertical stem portion SPE1_V. The first horizontal stem portion SPE1_H, the first vertical stem portion SPE1_V, and the plurality of first branch portions SPE1_B will be described below in detail with reference to FIGS. 5 and 6. The first outer portion SPE1_O opposes at least one of the first horizontal portion SPE1_H and the first vertical portion SPE1_V, and may connect end portions of the plurality of first branch portions SPE1_B.

The second connection electrode CNE2 connects the first sub-pixel electrode SPE1 and the second sub-pixel electrode SPE2. Specifically, the second connection electrode CNE2 extends from the first sub-pixel electrode SPE1 along the second direction DR2 and is connected to the second sub-pixel electrode SPE2. More specifically, the second connection electrode CNE2 extends from the first vertical stem portion SPE1_V along the second direction DR2 to connect the second vertical stem portion SPE2_V to be described below with the first vertical stem portion SPE1_V.

The second sub-pixel electrode SPE2 includes a second horizontal stem portion SPE2_H, a second vertical stem portion SPE2_V, a second branch portion SPE2_B, and a second outer portion SPE2_O.

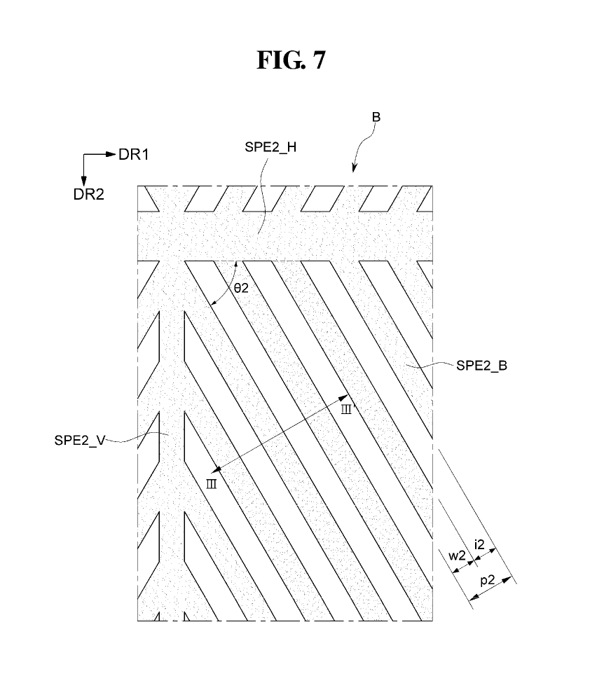

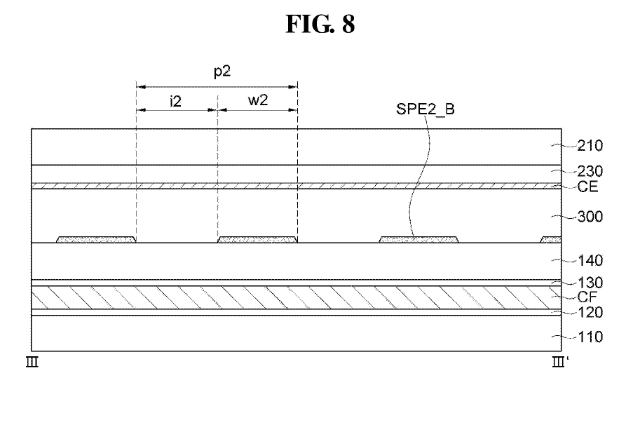

The second horizontal stem portion SPE2_H extends along the first direction DR1, and the second vertical stem portion SPE2_V extends along the second direction DR2 that intersects the first direction DR1. Each of the plurality of second branch portions SPE2_B extends obliquely from at least one of the second horizontal stem portion SPE2_H and the second vertical stem portion SPE2_V. The second horizontal stem portion SPE2_H, the second vertical stem portion SPE2_V and the plurality of second branch portions SPE2_B will be described below in detail with reference to FIGS. 7 and 8. The second outer portion SPE2_O opposes at least one of the second horizontal portion SPE2_H and the second vertical portion SPE2_V, and may connect end portions of the plurality of second branch portions SPE2_B.

According to an embodiment of the present inventive concept, the pixel electrode PE including the first connection electrode CNE1, the first sub-pixel electrode SPE1, the second connection electrode CNE2, and the second sub-pixel electrode SPE2 may be connected to each other, and receives a voltage transmitted from the drain electrode DE of the thin film transistor TFT. The first connection electrode CNE1, the first sub-pixel electrode SPE1, the second connection electrode CNE2, and the second sub-pixel electrode SPE2 receive substantially the same voltage.

According to an embodiment of the present inventive concept, the second organic layer 140 is disposed on the second sub-pixel electrode SPE2 and is not disposed on the first sub-pixel electrode SPE1. Accordingly, the electric field formed between the common electrode CE and the second sub-pixel electrode SPE2 disposed below the second organic layer 140 may have a different intensity from that of the electric field formed between the common electrode CE and the first sub-pixel electrode SPE1 where the second organic layer 140 is not disposed. In specific, a voltage applied between the second sub-pixel electrode SPE2 and the common electrode CE is distributed to the second organic layer 140, and thus the electric field formed between the common electrode CE and the first sub-pixel electrode SPE1 where the second organic layer 140 is not disposed may have an intensity greater than that of the electric field formed between the common electrode CE and the second sub-pixel electrode SPE2 where the second organic layer 140 is disposed. Accordingly, the liquid crystal layer 300 may be arranged at different angles in each case, and thus transmittances may be different in the area where the first sub-pixel electrode SPE1 is disposed and the area where the second sub-pixel electrode SPE2 is disposed.

The second organic layer 140 may have a single-layer or multilayer structure including, for example, a photosensitive organic material, and a silicon-based low dielectric constant insulating material.

A lower alignment layer (not illustrated) may be disposed on the pixel electrode PE. The lower alignment layer may be a vertical alignment layer or a photo alignment layer including a photopolymerizable material.

The second substrate 210 may be an insulating substrate having light transmission characteristics and flexible characteristics, e.g., a plastic substrate. However, exemplary embodiments are not limited thereto, and the second substrate 210 may include a hard substrate such as a glass substrate.

The black matrix BM may be located on the thin film transistor TFT. In addition, although not illustrated in the drawings, the black matrix BM may be disposed between the color filters CF in a plan view. The black matrix BM may include a photosensitive or non-photosensitive organic material.

A planarization layer 230 is disposed on the black matrix BM. The planarization layer 230 may planarize the uneven surface or substantially prevent the elution of impurities.

The common electrode CE is disposed on the planarization layer 230. The common electrode CE may be a through-plate electrode including a transparent conductor such as indium tin oxide (ITO) and indium zinc oxide (IZO). However, exemplary embodiments are not limited thereto, and the common electrode CE may have a concavo-convex shape and/or at least one slit for defining a plurality of domains.

The liquid crystal layer 300 may include vertically aligned liquid crystal molecules having a negative dielectric constant. However, exemplary embodiments are not limited thereto.

FIG. 5 is an enlarged view illustrating A in FIG. 3, and FIG. 6 is a cross-sectional view taken along line II-II′ of FIG. 5.

Referring to FIGS. 5 and 6, the first horizontal stem portion SPE1_H extends along the first direction DR1, and the first vertical stem portion SPE1_V extends along the second direction DR1 that intersects the first direction DR1. Each of the first branch portions SPE1_B extends obliquely from at least one of the first horizontal stem portion SPE1_H and the first vertical stem portion SPE1_V. According to an embodiment of the present inventive concept, each of the first branch portions SPE1_B may form an angle θ1 of about 40 degrees or more and about 50 degrees or less with respect to the first horizontal branch portion SPE1_H extending in the first direction DR1. However, exemplary embodiments are not limited thereto, and each of the first branch portions SPE1_B may form an angle θ1 of about 40 degrees or less and about 50 degrees or more with respect to the first horizontal branch portion SPE1_H extending in the first direction DR1.

According to a first embodiment of the present inventive concept, the plurality of first branch portions SPE1_B each have a first width w1 and are disposed apart from each other at a first interval i1. For example, the plurality of first branch portions SPE1_B may each have the first width w1 of about 3.3 μm or more and about 3.7 μm or less, and may be spaced apart from each other at the first interval i1 of about 2.3 μm or more and about 2.7 μm or less. More specifically, the plurality of first branch portions SPE1_B may each have the first width w1 of about 3.5 μm, and may be spaced apart from each other at the first interval i1 of about 2.5 μm. Accordingly, according to a first embodiment of the present inventive concept, a ratio of the first width w1 of the first branch portion SPE1_B to the first interval i1 between the plurality of first branch portions SPE1_B may be about 1.2 or more and about 1.7 or less.

When the respective sum of the widths w1 and w2 and the intervals i1 and i2 of the branch portions SPE1_B and SPE2_B are defined as a pitch of the branch portions SPE1_B and SPE2_B, respectively, the plurality of first branch portions SPE1_B may be arranged at a predetermined pitch. According to a first embodiment of the present inventive concept, the plurality of first branch portions SPE1_B may be arranged at a pitch substantially equal to that of the plurality of second branch portions SPE2_B. However, exemplary embodiments are not limited thereto, and the plurality of first branch portions SPE1_B may be arranged at a pitch different from that of the plurality of second branch portions SPE2_B.

The plurality of first branch portions SPE1_B may be arranged at a pitch of about 6 μm. However, exemplary embodiments are not limited thereto, and the plurality of second branch portions SPE2_B may be arranged at a pitch of about 5 μm or about 7 μm.

FIG. 7 is an enlarged view illustrating B in FIG. 3, and FIG. 8 is a cross-sectional view taken along line III-III′ of FIG. 7.

Referring to FIGS. 7 and 8, the second horizontal stem portion SPE2_H extends along the first direction DR1, and the second vertical stem portion SPE2_V extends along the second direction DR2 that intersects the first direction DR1. Each of the plurality of second branch portions SPE2_B extends obliquely from at least one of the second horizontal stem portion SPE2_H and the second vertical stem portion SPE2_V. According to an embodiment of the present inventive concept, each of the plurality of second branch portions SPE2_B may form an angle θ2 of about 25 degrees or more and about 40 degrees or less with respect to the second horizontal branch portion SPE2_H extending in the first direction DR1.

According to an embodiment of the present inventive concept, the first branch portion SPE1_B and the first horizontal stem portion SPE1_H may form an angle different from the angle between the second branch portion SPE2_B and the second horizontal stem portion SPE2_H. However, exemplary embodiments are not limited thereto, and the first branch portion SPE1_B and the first horizontal stem portion SPE1_H may form an angle substantially equal to the angle between the second branch portion SPE2_B and the second horizontal stem portion SPE2_H.

According to a first embodiment of the present inventive concept, the plurality of second branch portions SPE2_B may be arranged at a predetermined pitch. For example, the plurality of second branch portions SPE2_B may be arranged at a pitch of about 6 μm. However, exemplary embodiments are not limited thereto, and the plurality of second branch portions SPE2_B may be arranged at a pitch of about 5 μm or about 7 μm.

According to a first embodiment of the present inventive concept, the plurality of second branch portions SPE2_B each have a second width w2 and are disposed apart from each other at a second interval i2. For example, the plurality of second branch portions SPE2_B may each have the second width w2 of about 2.9 μm or more and about 3.1 μm or less, and may be spaced apart from each other at the second interval i2 of about 2.9 μm or more and about 3.1 μm or less. More specifically, the plurality of second branch portions SPE2_B may each have the second width w2 of about 2.9 μm, and may be spaced apart from each other at the second interval i2 of about 3.1 μm. Accordingly, according to a first embodiment of the present inventive concept, a ratio of the second width w2 of the second branch portion SPE2_B to the second interval i2 between the plurality of second branch portions SPE2_B may be about 0.9 or more and about 1.2 or less.

According to a first embodiment of the present inventive concept, as illustrated in FIGS. 5 to 8, the second branch portions SPE2_B may be disposed apart from each other at a greater interval (i2>i 1) than the interval between the first branch portions SPE1_B, and the second branch portions SPE2_B may each have a less width (w2<w1) than the width of each of the first branch portions SPE1_B.

In addition, according to a first embodiment of the present inventive concept, the ratio of the first width w1 of the first branch portion SPE1_B to the first interval i1 between the plurality of first branch portions SPE1_B may be greater than the ratio of the second width w2 of the second branch portion SPE2_B to the second interval i2 between the plurality of second branch portions SPE2_B. According to a first embodiment of the present inventive concept, since the ratio of the second width w2 of the second branch portion SPE2_B to the second interval i2 between the plurality of second branch portions SPE2_B is less than the ratio of the first width w1 of the first branch portion SPE1_B to the first interval i2 between the plurality of first branch portions SPE1_B, the liquid crystal controllability in the area where the second sub-pixel electrode SPE2 including the plurality of second branch portions SPE2_B is disposed may be improved and thus the transmittance in the area may be improved.

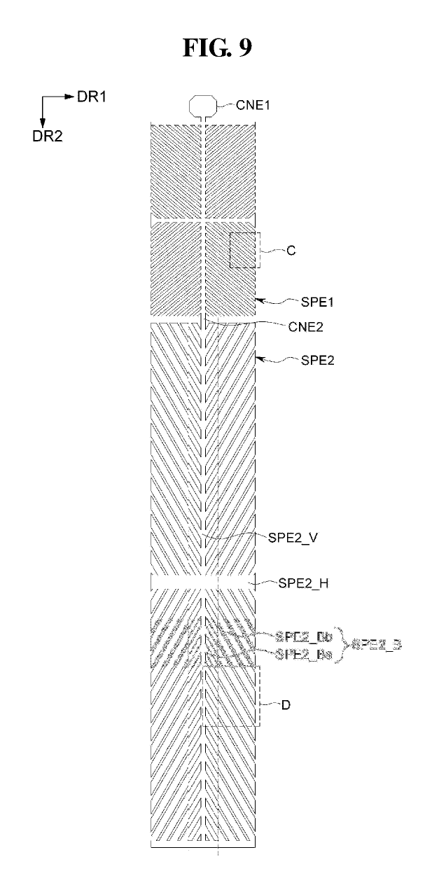

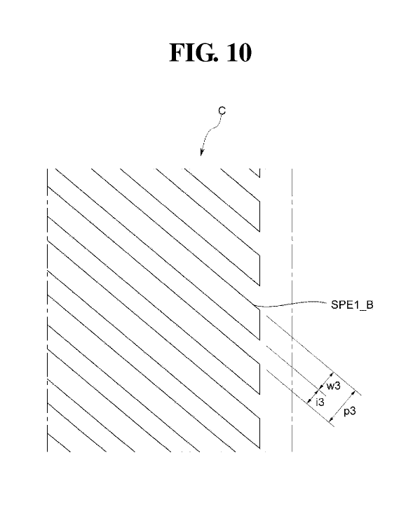

Hereinafter, a display device according to a second embodiment of the present inventive concept will be described with reference to FIGS. 9 to 11. Hereinafter, the description of the components already described will be omitted to avoid redundancy.

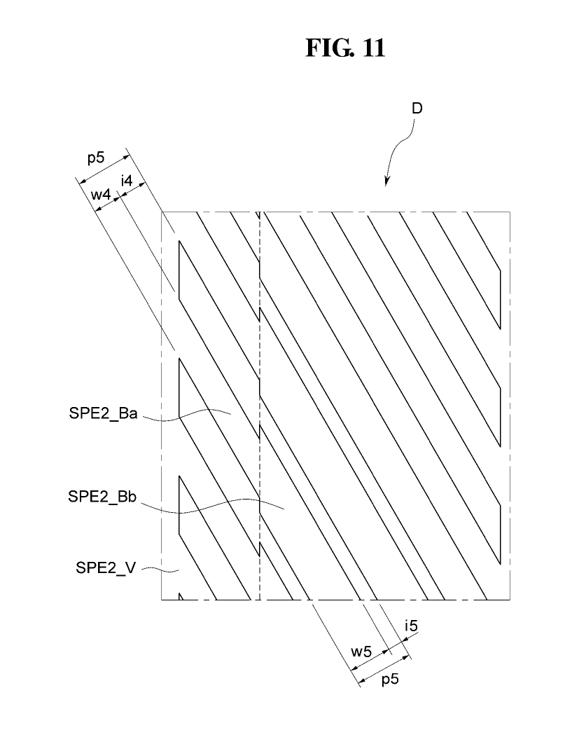

FIG. 9 is a plan view illustrating one pixel electrode according to a second embodiment of the present inventive concept, FIG. 10 is an enlarged view illustrating C in FIG. 9, and FIG. 11 is an enlarged view illustrating D in FIG. 9.

According to a second embodiment of the present inventive concept, a plurality of first branch portions SPE1_B each have a third width w3 and are disposed apart from each other at a third interval i3. For example, the plurality of first branch portions SPE1_B may each have the third width w3 of about 3.3 μm or more and about 3.7 μm or less, and may be spaced apart from each other at the third interval i3 of about 2.3 μm or more and about 2.7 μm or less. More specifically, the plurality of first branch portions SPE1_B may each have the third width w3 of about 3.5 μm, and may be spaced apart from each other at the third interval i3 of about 2.5 μm.

Accordingly, according to a second embodiment of the present inventive concept, a ratio of the third width w3 of the first branch portion SPE1_B to the third interval i3 between the plurality of first branch portions SPE1_B may be about 1.2 or more and about 1.7 or less.

A second sub-pixel electrode SPE2 includes a second horizontal stem portion SPE2_H, a second vertical stem portion SPE2_V, and a second branch portion SPE2_B. The second branch portion SPE2_B may include a center portion SPE2_Ba and an end portion SPE2_Bb other than the center portion SPE2_Ba. For example, the center portion SPE2_Ba may be disposed on both side of the second vertical stem portion SPE2_V and may be quadrangular in a plan view. A length of the center portion SPE2_Ba may be less than half of a length of the second branch portions SPE2_B. The length of the center portion SPE2_Ba may be longer at a center of the second sub-pixel electrode SPE2 and may be shorter at an end of the second sub-pixel electrode SPE2 along the second direction. However, the planar shape of the center portion SPE2_Ba is not limited thereto.

The center portions SPE2_Ba of the plurality of second branch portions SPE2_B that are adjacent to the second vertical stem portion SPE2_V each have a fourth width w4 and are disposed apart from each other at a fourth interval i4. For example, the center portions SPE2_Ba of the plurality of second branch portions SPE2_B that are adjacent to the second vertical stem portion SPE2_V may each have the fourth width w4 of about 2.9 μm or more and about 3.1 μm or less, and may be spaced apart from each other at the fourth interval i4 of about 2.9 μm or more and about 3.1 μm or less. More specifically, the center portions SPE2_Ba of the plurality of second branch portions SPE2_B that are adjacent to the second vertical stem portion SPE2_V may each have the fourth width w4 of about 2.9 μm, and may be spaced apart from each other at the fourth interval i4 of about 3.1 μm.

The end portions SPE2_Bb of the plurality of second branch portions SPE2_B each have a fifth width w5 and are disposed apart from each other at a fifth interval i5.

According to a second embodiment of the present inventive concept, a pitch p3 of the first branch portion SPE2_B is substantially equal to pitches p4 and p5 of the second branch portion SPE2_B.

According to a second embodiment of the present inventive concept, the center portions SPE2_Ba of the second branch portions SPE2_B each have a less width (w4<w5) than the width of each of the end portions SPE2_Bb of the second branch portions SPE2_B, and are disposed apart from each other at a greater interval (i4>i5) than the interval between the end portions SPE2_Bb of the second branch portions SPE2_B.

According to a second embodiment of the present inventive concept, the center portions SPE2_Ba of the second branch portions SPE2_B each have a less width (w3>w4) than the width of each of the first branch portions SPE1_B, and are disposed apart from each other at a greater interval (i3<i4) than the interval between the first branch portions SPE1_B.

Accordingly, according to a second embodiment of the present inventive concept, the transmittance and side visibility of the center portion SPE2_Ba may be improved.

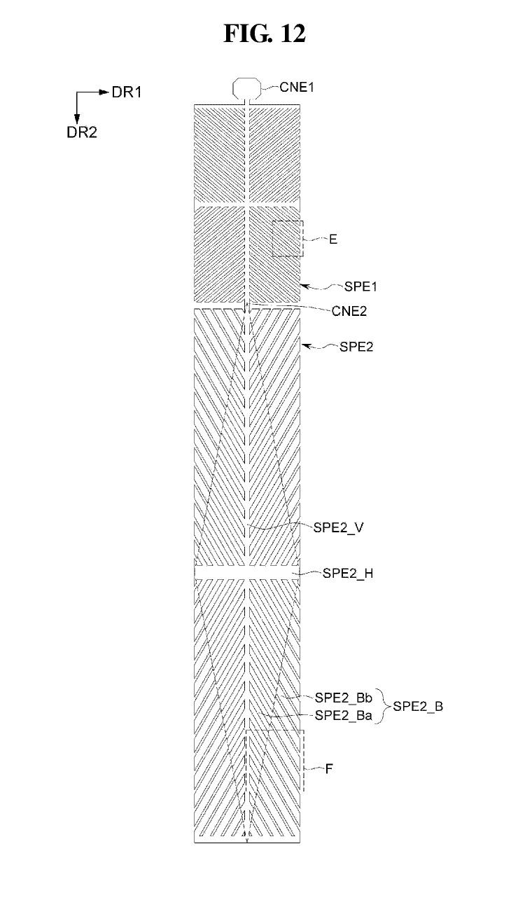

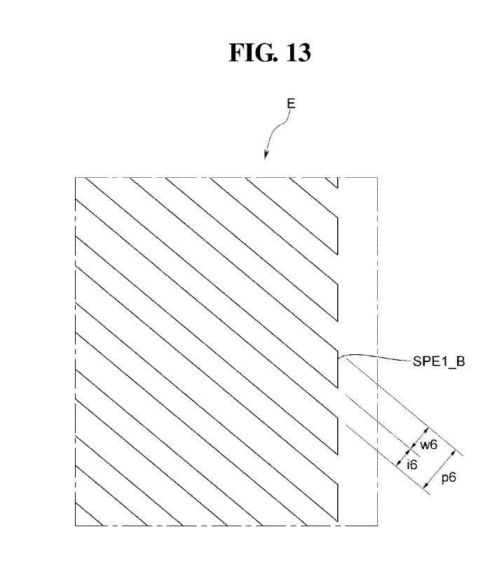

Hereinafter, a display device according to a third embodiment of the present inventive concept will be described with reference to FIGS. 12 to 14. Hereinafter, the description of the components already described will be omitted to avoid redundancy.

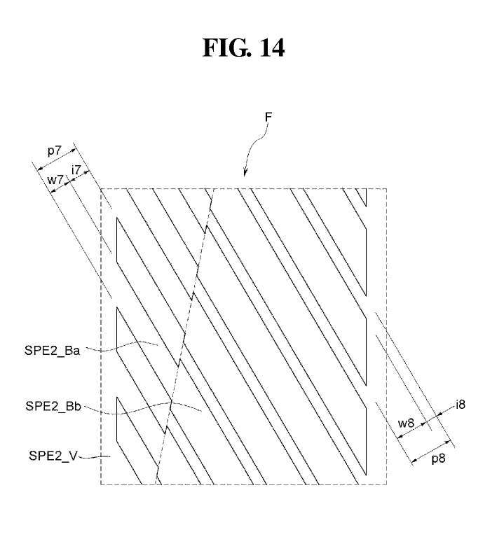

FIG. 12 is a plan view illustrating one pixel electrode according to a third embodiment of the present inventive concept, FIG. 13 is an enlarged view illustrating E in FIG. 12, and FIG. 14 is an enlarged view illustrating F in FIG. 12.

According to a third embodiment of the present inventive concept, a plurality of first branch portions SPE1_B each have a sixth width w6 and are disposed apart from each other at a sixth interval i6. For example, the plurality of first branch portions SPE1_B may each have the sixth width w6 of about 3.3 μm or more and about 3.7 μm or less, and may be spaced apart from each other at the sixth interval i6 of about 2.3 μm or more and about 2.7 μm or less. More specifically, the plurality of first branch portions SPE1_B may each have the sixth width w6 of about 3.5 μm, and may be spaced apart from each other at the sixth interval i6 of about 2.5 μm. Accordingly, according to a third embodiment of the present inventive concept, a ratio of the sixth width w6 of each of the first branch portions SPE1_B to the sixth interval i6 between the plurality of first branch portions SPE1_B may be about 1.2 or more and about 1.7 or less.

A second sub-pixel electrode SPE2 includes a second vertical stem portion SPE2_V and a second branch portion SPE2_B adjacent to the second vertical stem portion SPE2_V. The second branch portion SPE2_B may include a center portion SPE2_Ba and an end portion SPE2_Bb corresponding to the area other than the center portion SPE2_Ba. For example, the center portion SPE2_Ba may be rhombic in a plan view. However, the planar shape of the center portion SPE2_Ba is not limited thereto.

The center portions SPE2_Ba of the plurality of second branch portions SPE2_B each have a seventh width w7 and are disposed apart from each other at a seventh interval i7. For example, the center portions SPE2_Ba of the plurality of second branch portions SPE2_B may each have the seventh width w7 of about 2.9 μm or more and about 3.1 μm or less, and may be spaced apart from each other at the seventh interval i7 of about 2.9 μm or more and about 3.1 μm or less. More specifically, the center portions SPE2_Ba of the plurality of second branch portions SPE2_B may each have the seventh width w7 of about 2.9 μm, and may be spaced apart from each other at the seventh interval i7of about 3.1 μm.

The end portions SPE2_Bb of the plurality of second branch portions SPE2_B each have an eighth width w8 and are disposed apart from each other at an eighth interval i8.

According to a third embodiment of the present inventive concept, a pitch p6 of the first branch portion SPE1_B is substantially equal to pitches p7 and p8 of the second branch portion SPE2_B.

According to a third embodiment of the present inventive concept, the center portions SPE2_Ba of the second branch portions SPE2_B each have a less width (w7<w8) than the width of each of the end portions SPE2_Bb of the second branch portions SPE2_B, and are disposed apart from each other at a greater interval (i7>i8) than the interval between the end portions SPE2_Bb of the second branch portions SPE2_B.

Accordingly, according to a third embodiment of the present inventive concept, the transmittance and side visibility of the center portion SPE2_Ba of the second branch portion SPE2_B may be improved.

As set forth hereinabove, according to one or more embodiments of the present inventive concept, the liquid crystal controllability may be improved by adjusting the ratio of the width of the branch portion of the pixel electrode to the interval between the branch portions, and thereby the transmittance and side visibility of the display device may be improved.

While the present inventive concept has been illustrated and described with reference to the embodiments thereof, it will be apparent to those of ordinary skill in the art that various changes in form and detail may be formed thereto without departing from the spirit and scope according to an embodiment of the present inventive concept.

What is claimed is:

1. A display device comprising:
a substrate;
a thin film transistor disposed on the substrate; and
a pixel electrode disposed on the thin film transistor and comprising a first sub-pixel electrode and a second sub-pixel electrode connected to the first sub-pixel electrode,
wherein the first sub-pixel electrode comprises:
a first horizontal stem portion extending along a first direction,
a first vertical stem portion extending along a second direction that intersects the first direction, and
a plurality of first branch portions obliquely extending from at least one of the first horizontal stem portion and the first vertical stem portion,
wherein the second sub-pixel electrode comprises:
a second horizontal stem portion extending along the first direction,
a second vertical stem portion extending along the second direction, and
a plurality of second branch portions obliquely extending from at least one of the second horizontal stem portion and the second vertical stem portion,
wherein the plurality of second branch portions are arranged at a pitch substantially equal to a pitch of the plurality of first branch portions, and
wherein an interval between the plurality of second branch portions is greater than an interval between the plurality of first branch portions.

2. The display device of claim 1, wherein a ratio of a width of each of the plurality of first branch portions to an interval between the plurality of first branch portions is greater than a ratio of a width of each of the plurality of second branch portions to an interval between the plurality of second branch portions.

3. The display device of claim 2, wherein the ratio of the width of each of the plurality of first branch portions to the interval between the plurality of first branch portions is about 1.2 or more and about 1.7 or less.

4. The display device of claim 3, wherein the ratio of the width of each of the plurality of second branch portions to the interval between the plurality of second branch portions is about 0.9 or more and about 1.2 or less.

5. The display device of claim 1, wherein the plurality of first branch portions are arranged at a pitch of about 5 μm or more and about 7 μm or less, and the plurality of second branch portions are arranged at a pitch of about 5 μm or more and about 7 μm or less.

6. The display device of claim 1, further comprising a first organic layer disposed between the thin film transistor and the pixel electrode; and
a second organic layer disposed on the second sub-pixel electrode.

7. The display device of claim 6, wherein the first organic layer that overlaps the first sub-pixel electrode has a thickness larger than a thickness of the first organic layer that overlaps the second sub-pixel electrode.

8. The display device of claim 6, wherein the second organic layer is not disposed on the first sub-pixel electrode.

9. The display device of claim 1, wherein each of the plurality of second branch portions has a width less than a width of each of the plurality of first branch portions.

10. The display device of claim 1, wherein the pixel electrode further comprises a first connection portion which is connected to the thin film transistor, and a second connection portion which connects the first sub-pixel electrode and the second sub-pixel electrode.

11. The display device of claim 1, wherein the first branch portion and the first horizontal stem portion form an angle different from an angle between the second branch portion and the second horizontal stem portion.

12. The display device of claim 1, wherein the first branch portion and the first horizontal stem portion form an angle of about 40 degrees or more and about 50 degrees or less.

13. The display device of claim 1, wherein the second branch portion and the second horizontal stem portion form an angle of about 25 degrees or more and about 40 degrees or less.

14. The display device of claim 1, wherein the first sub-pixel electrode comprises an outer electrode connecting end portions of the first branch portions.

15. A display device comprising:
a substrate;
a thin film transistor disposed on the substrate; and
a pixel electrode disposed on the thin film transistor and comprising a first sub-pixel electrode and a second sub-pixel electrode connected to the first sub-pixel electrode,
wherein the first sub-pixel electrode comprises a first horizontal stem portion extending along a first direction, a first vertical stem portion extending along a second direction that intersects the first direction, and a plurality of first branch portions obliquely extending from at least one of the first horizontal stem portion and the first vertical stem portion,
wherein the second sub-pixel electrode comprises a second horizontal stem portion extending along the first direction, a second vertical stem portion extending along the second direction, and a plurality of second branch portions obliquely extending from at least one of the second horizontal stem portion and the second vertical stem portion,
wherein a ratio of a width of each of the plurality of first branch portions to an interval between the plurality of first branch portions is about 1.2 or more and about 1.6 or less, and
wherein a ratio of a width of each of the plurality of second branch portions to an interval between the plurality of second branch portions is about 0.9 or more and about 1.2 or less.

16. The display device of claim 15, wherein the plurality of first branch portions are arranged at a pitch of about 5 μm or more and about 7 μm or less, and the plurality of second branch portions are arranged at a pitch of about 5 μm or more and about 7 μm or less.

17. The display device of claim 15, further comprising a first organic layer disposed between the thin film transistor and the pixel electrode; and
a second organic layer disposed on the second sub-pixel electrode.

18. The display device of claim 17, wherein the first organic layer that overlaps the first sub-pixel electrode has a thickness larger than a thickness of the first organic layer that overlaps the second sub-pixel electrode.

19. The display device of claim 17, wherein the second organic layer is not disposed on the first sub-pixel electrode.

20. The display device of claim 15, wherein each of the plurality of second branch portions has a width less than a width of each of the plurality of first branch portions.

21. A display device comprising:
a substrate;
a thin film transistor disposed on the substrate; and
a pixel electrode disposed on the thin film transistor and comprising a first sub-pixel electrode and a second sub-pixel electrode connected to the first sub-pixel electrode,
wherein the first sub-pixel electrode comprises a first horizontal stem portion extending along a first direction, a first vertical stem portion extending along a second direction that intersects the first direction, and a plurality of first branch portions obliquely extending from at least one of the first horizontal stem portion and the first vertical stem portion,
wherein the second sub-pixel electrode comprises a second horizontal stem portion extending along the first direction, a second vertical stem portion extending along the second direction, and a plurality of second branch portions obliquely extending from at least one of the second horizontal stem portion and the second vertical stem portion,
wherein the plurality of second branch portions are arranged at a pitch substantially equal to a pitch of the plurality of first branch portions, and
wherein each of the plurality of second branch portions has a less width at a center portion than a width at an end portion.

22. The display device of claim 21, wherein the center portion of each of the plurality of second branch portions has a width less than a width of each of the plurality of first branch portions.

23. The display device of claim 21, wherein the plurality of first branch portions are arranged at a pitch of about 5 μm or more and about 7 μm or less, and the plurality of second branch portions are arranged at a pitch of about 5 μm or more and about 7 μm or less.

24. The display device of claim 21, further comprising a first organic layer disposed between the thin film transistor and the pixel electrode; and
a second organic layer disposed on the second sub-pixel electrode.

25. The display device of claim 24, wherein the first organic layer that overlaps the first sub-pixel electrode has a thickness larger than a thickness of the first organic layer that overlaps the second sub-pixel electrode.

26. The display device of claim 24, wherein the second organic layer is not disposed on the first sub-pixel electrode.
